(19) United States
(12) Patent Application Publication
(10) Pub. No.: US 2009/0144071 A1
(43) Pub. Date: Jun. 4, 2009

(54) INFORMATION PROCESSING TERMINAL, METHOD FOR INFORMATION PROCESSING, AND PROGRAM

(76) Inventors: Mari Saito, Kanagawa (JP); Noriyuki Yamamoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/272,040

(22) Filed: Nov. 17, 2008

(30) Foreign Application Priority Data
Dec. 3, 2007 (JP) 2007-312030

(51) Int. Cl. G06Q 99/00

(52) U.S. Cl. 705/1

(57) ABSTRACT

An information processing terminal includes an acquiring unit configured to acquire biological information concerning a biological reaction of a user to each content block during playback of the content block, a group specifying unit configured to specify a group of content blocks, to which the user has similar biological reactions during playback, on the basis of the biological information acquired through the acquiring unit, a recommended content specifying unit configured to specify as recommended content a content block belonging to the same group as that to which a reference content block belongs, and a recommending unit configured to present information concerning the recommended content specified by the recommended content specifying unit to the user.

### CROSS REFERENCES TO RELATED APPLICATIONS

The present invention contains subject matter related to Japanese Patent Application JP 2007-312030 filed in the Japanese Patent Office on Dec. 3, 2007, the entire contents of which are incorporated herein by reference.

### BACKGROUND OF THE INVENTION

1. Field of the Invention

The present invention relates to an information processing terminal, a method for information processing, and a program, and in particular, to an information processing terminal and method capable of more appropriately recommending a piece of content on the basis of biological information, and a program therefor.

2. Description of the Related Art

There is a technique of specifying a user who exhibits a reaction similar to that of a target user on the basis of purchase histories and behavior histories of a plurality of users and recommending a piece of content (hereinafter, referred to as “content block”) that the target user has not yet experienced to the target user on the basis of the histories of the specified user. Such a technique is called “collaborative filtering” (P. Resnick, N. Iacovou, M. Suchak, P. Bergstrom, and J. Riedl, “GroupLens: Open Architecture for Collaborative Filtering of Netnews”, Conference on Computer Supported Cooperative Work, pp. 175-186, 1994).

According to this technique, the target user can be recommended a content block that the user has not experienced, i.e., viewed or listened to and that has been purchased by another user who has a reaction similar to that of the target user and is highly evaluated by the other user.

### SUMMARY OF THE INVENTION

Collaborative filtering is effective in allowing a user to make decision on buying a product but is not effective in recommending something that a user's reaction varies in time series while using it, such as a content block.

A reaction of a reference user as a criterion for selecting a recommended content block is, for example, “like”, “dislike”, or “neither”, i.e., the final reaction to the content. Details leading to the final reaction, e.g., what portion of the content the reference user likes or dislikes, are not taken into consideration.

Although a user can consciously evaluate whether the user likes or dislikes a content block, it is difficult to express liking or disliking the content in words because how the user feels.

There is a technique of monitoring brain waves and a perspiration state to obtain biological information to predict user's emotion on the basis of the biological information.

In application of this technique to content recommendation, the following case may be considered: Biological information is actually obtained while, for example, a user is viewing or listening to a content block, the user's emotion is predicted on the basis of the biological information, a content block that has allowed the user to have the same emotion as the predicted one is retrieved, and the retrieved content is recommended to the user. In this case, however, it is difficult to specify and recommend a content block that the user has not viewed or listened to and will be interested in.

The present invention has been made in consideration of the above-described circumstances. It is desirable to more appropriately recommend a content block on the basis of biological information.

According to an embodiment of the present invention, an information processing terminal includes acquiring means for acquiring biological information concerning a biological reaction of a user to each content block during playback of the content block, group specifying means for specifying a group of content blocks, to which the user has similar biological reactions during playback, on the basis of the biological information acquired through the acquiring means, recommended content specifying means for specifying as recommended content a content block belonging to the same group as that to which a reference content block belongs, and recommending means for presenting information concerning the recommended content specified by the recommended content specifying means to the user.

In the embodiment, the information processing terminal may be connected to an information processing apparatus via a network. The information processing apparatus acquires biological information blocks of a plurality of users and manages the biological information blocks, each information block concerning a biological reaction of a user to each content block during playback of the content block. The information processing terminal may further include communication means for communicating with the information processing apparatus to acquire the biological information blocks managed by the information processing apparatus.

In this embodiment, the information processing terminal may further include user specifying means for specifying a similar user who has a biological reaction similar to that of the user of the information processing terminal during playback of the same content block from among the users providing the biological information blocks to the information processing apparatus on the basis of the biological information blocks acquired through the communication means from the information processing apparatus. In this case, the group specifying means may specify a group of content blocks, to which the users have similar biological reactions, on the basis of the biological information acquired through the acquiring means and the biological information, concerning the biological reaction of the similar user specified by the user specifying means, among the biological information blocks acquired through the communication means.

According to another embodiment of the present invention, there is provided a method for information processing, the method including the steps of acquiring biological information concerning a biological reaction of a user to each content block during playback of the content block, specifying a group of content blocks, to which the user has similar biological reactions during playback, on the basis of the acquired biological information, specifying as recommended content a content block belonging to the same group as that to which a reference content block belongs, and presenting information concerning the recommended content to the user.

According to another embodiment of the present invention, there is provided a program that allows a computer to perform a process including the steps of acquiring biological information concerning a biological reaction of a user to each content block during playback of the content block, specifying a group of content blocks, to which the user has similar biological reactions during playback, on the basis of the acquired biological information, specifying as recommended content a content block belonging to the same group as that to which a reference content block belongs, and presenting information concerning the recommended content to the user.

According to any of the embodiments of the present invention, biological information concerning a biological reaction of a user to each content block during playback of the content block is acquired. A group of content blocks to which the user has similar biological reactions during playback is specified on the basis of the acquired biological information. A content block belonging to the same group as that to which a reference content block belongs is specified as recommended content and information concerning the recommended content is presented to the user.

According to the embodiments of the present invention, a content block can be recommended more appropriately on the basis of biological information.

### BRIEF DESCRIPTION OF THE DRAWINGS

FIG. 1 is a block diagram illustrating the structure of a content recommendation system according to an embodiment of the present invention;

FIG. 2 is a diagram illustrating a situation where a content block is being played;

FIG. 3 is a diagram showing an example of time-series data concerning a biological reaction;

FIG. 4 is a diagram showing examples of biological information blocks;

FIG. 5 is a diagram showing examples of evaluations of content blocks and viewing histories of respective users;

FIG. 6 is a flowchart explaining a content playback process by a client;

FIG. 7 is a flowchart explaining a content recommendation process by a server;

FIG. 8 is a flowchart explaining a recommendation result display process by the client;

FIG. 9 is a diagram illustrating a situation where a content block is being played;

FIG. 10 is a diagram showing examples of time-series data blocks concerning expressions;

FIG. 11 is a block diagram illustrating the structure of a content recommendation system according to another embodiment of the present invention;

FIG. 12 is a diagram showing examples of time-series data blocks concerning biological reactions;

FIG. 13 is a flowchart explaining a content playback process by a client;

FIG. 14 is a flowchart explaining a content recommendation process by the client;

FIG. 15 is a block diagram illustrating the structure of a content recommendation system according to another embodiment of the present invention;

FIG. 16 is a diagram showing examples of time-series data blocks concerning biological reactions;

FIG. 17 is a flowchart explaining a content recommendation process by a client;

FIG. 18 is a block diagram illustrating the structure of a content recommendation system according to another embodiment of the present invention;

FIG. 19 is a diagram showing examples of time-series data blocks concerning biological reactions;

FIG. 20 is a diagram showing examples of metadata blocks;

FIG. 21 is a flowchart explaining a content playback process by a client;

FIG. 22 is a flowchart explaining a content recommendation process by the client; and

FIG. 23 is a block diagram illustrating the hardware structure of a computer.

### DESCRIPTION OF THE PREFERRED EMBODIMENTS

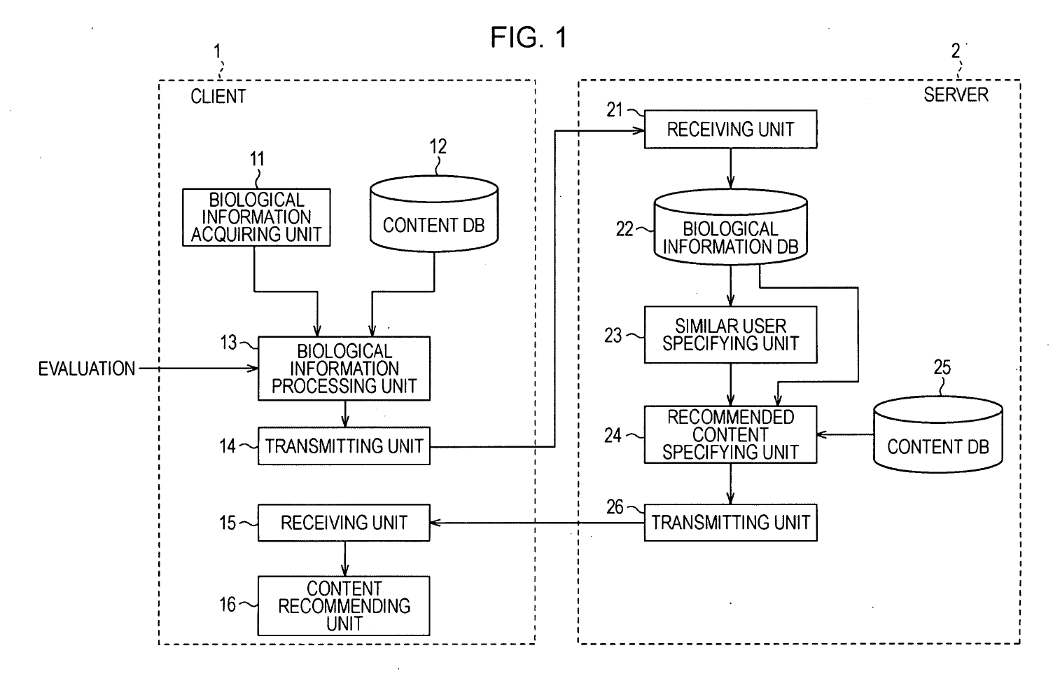

FIG. 1 is a block diagram illustrating the structure of a content recommendation system according to an embodiment of the present invention.

Referring to FIG. 1, the content recommendation system includes a client 1 and a server 2 such that the client 1 is connected to the server 2 via a network, such as the Internet.

The client 1 includes a biological information acquiring unit 11, a content database (DB) 12, a biological information processing unit 13, a transmitting unit 14, a receiving unit 15, and a content recommending unit 16. The server 2 includes a receiving unit 21, a biological information database (DB) 22, a similar user specifying unit 23, a recommended content specifying unit 24, a content DB 25, and a transmitting unit 26.

As will be described in detail below, the server 2 specifies a user that has a biological reaction, similar to that of a user operating the client 1, to a content block during viewing or listening to the content and recommends a content block that the user of the client 1 has not experienced and is highly evaluated by the user, who has the similar biological reaction, to the user of the client 1.

In other words, the server 2 is an apparatus that recommends a content block by collaborative filtering. The server 2 is connected to the client 1 and other terminals having the same structure as that of the client 1 via the network.

The biological reaction includes the content of hemoglobin in blood, blood flow, perspiration rate, or pulse. Any reaction exhibited by a user viewing or listening to a content block may be used as a biological reaction.

The biological information acquiring unit 11 in the client 1 detects a biological reaction of the user viewing or listening to a content block during playback of the content to acquire biological information, serving as time-series data concerning the detected biological reaction. The biological information also contains information about which content block was played to acquire the biological information.

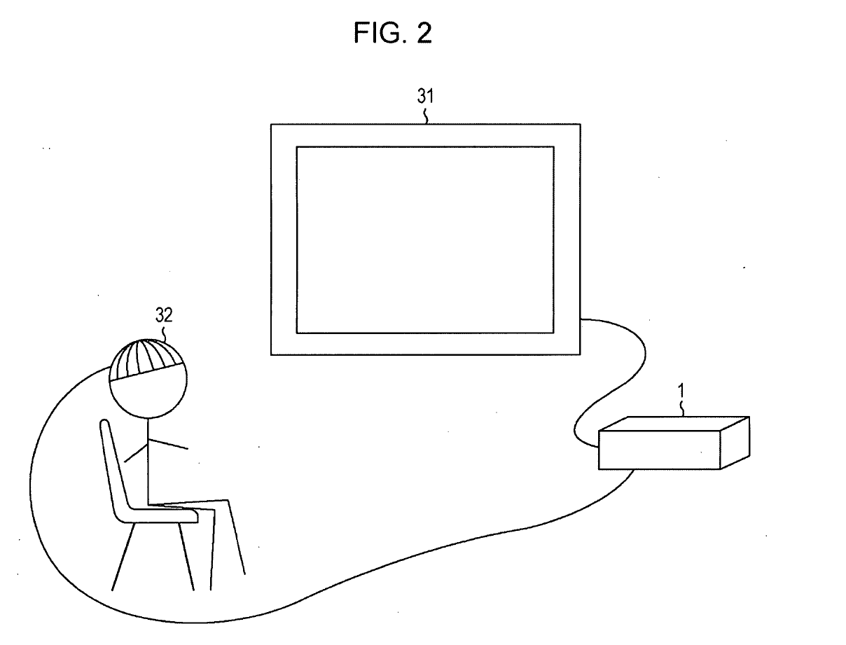

FIG. 2 is a diagram illustrating a situation where a content block is being played.

Referring to FIG. 2, a television receiver 31 and a headgear 32 are connected to the client 1 of the client 1. The headgear 32 is mounted on the head of the user, who sits on a chair in front of the television receiver 31 to view the content.

The video of the content played by the client 1 is displayed on the television receiver 31 and the sound of the content is output from a speaker unit of the television receiver 31.

During playback of the content, the headgear 32 irradiates near-infrared light to respective parts of the user's head to measure the content of hemoglobin that reacts with oxygen consumed during brain activity as a biological reaction. A signal,indicative of the measured biological reaction is supplied from the headgear 32 to the client 1, so that the biological information acquiring unit 11 acquires biological information.

FIG. 2 shows the case where the hemoglobin content of blood is used as a biological reaction. When another reaction is used as a biological reaction, a measuring device is similarly attached to the user viewing the content.

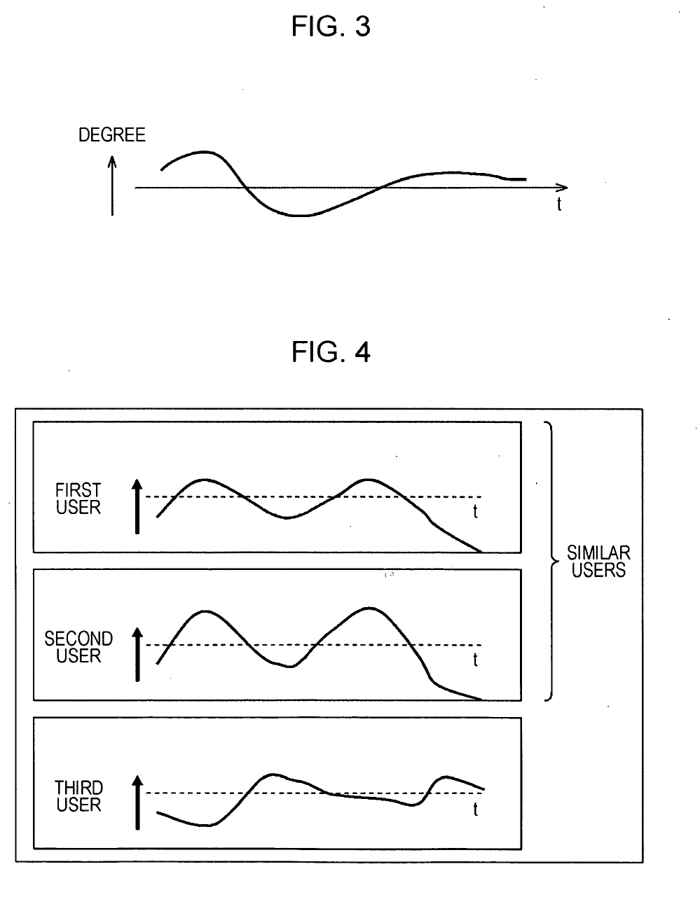

FIG. 3 shows an example of time-series data concerning a biological reaction.

Referring to FIG. 3, the biological reaction is acquired as the time-series data. FIG. 3 shows the degree (the hemoglobin content of blood in the above-described case) plotted against time.

The biological information acquiring unit 11 outputs the biological information acquired in the above-described manner to the biological information processing unit 13. In the client 1, a plurality of content blocks are played. Biological information blocks, each serving as time-series data as shown in FIG. 3, are acquired for the respective played content blocks.

The biological information processing unit 13 reads out a content block stored in the content DB 12 and plays the read-out content such that the television receiver 31 is allowed to output the video and sound of the content. The biological information processing unit 13 acquires biological information sequentially supplied from the biological information acquiring unit 11 during playback of the content.

In addition, the biological information processing unit 13 acquires a user evaluation of a content block. For example, when playback of one content block is finished, the user is prompted to enter an evaluation. The user operates a remote control or a mouse to enter an evaluation.

The biological information processing unit 13 outputs the biological information supplied from the biological information acquiring unit 11, an evaluation of each content block, and information concerning user's viewing history to the transmitting unit 14.

The transmitting unit 14 transmits the information blocks supplied from the biological information processing unit 13 to the server 2. Specifically, the biological information blocks and the evaluations of the respective content blocks that the user of the client 1 has experienced are provided to the server 2 such that biological information and an evaluation are associated with each content block.

The receiving unit 15 receives information relating to a recommended content block transmitted from the server 2 and outputs the received information to the content recommending unit 16.

The content recommending unit 16 displays the information relating to the recommended content specified by the server 2 on the television receiver 31 on the basis of the information supplied from the receiving unit 15 to present the recommended content to the user. For example, the title of the recommended content, a summary thereof, and a distribution source are displayed as the information relating to the recommended content.

The receiving unit 21 of the server 2 receives the biological information blocks transmitted from the transmitting unit 14 of the client 1, the user evaluations of the respective content blocks, and the information concerning the user's viewing history and stores the received information blocks in the biological information DB 22.

As described above, the server 2 is connected to the terminals having the same structure as that of the client 1. The respective terminals supply similar information blocks to the server 2, so that the biological information DB 22 stores biological information blocks of respective users, users' evaluations of content blocks, and viewing history information blocks.

The similar user specifying unit 23 reads out the biological information blocks from the biological information DB 22 and specifies users who have similar biological reactions to the same content block during viewing the content on the basis of patterns of the time-series data blocks concerning the biological reactions of the respective users.

Whether the patterns of the time-series data blocks concerning the biological reactions are similar is determined by, for example, obtaining the cross-correlation between the patterns of the time-series data blocks concerning the biological reactions of the respective users, obtaining the degree of agreement between each pattern and a specific pattern, or obtaining the degree of agreement between each pattern in a specific portion (range) and a threshold.

FIG. 4 shows examples of biological information blocks relating to content A.

Referring to FIG. 4, patterns of time-series data blocks concerning biological reactions of first to third users acquired during viewing the content A are shown in order from the top.

In the case where the patterns of the time-series data blocks concerning the respective biological reactions of the first to third users to the content A are obtained as shown in FIG. 4, the pattern of the first user is similar to that of the second user. Accordingly, the first and second users are similar users who exhibit similar biological reactions to the content A during viewing the content A.

During viewing the content A, the first and second users exhibit similar degrees of biological reactions to similar portions of the content A.

On the other hand, since the first user is not similar to the third user, the first and third users exhibit different degrees of biological reactions to different portions of the content A during viewing the content A.

The above-described hemoglobin content of blood used as a biological reaction represents brain activity. It is estimated that the brain activity of a user varies depending on the user's feeling during viewing or listening to a content block. Accordingly, similar users have similar ways of feeling about a certain feature of content, or exhibit similar reactions to the certain feature of content. In other words, similar users have similar ways of viewing or listening to content. Ways of viewing or listening to the same content block are different among people. For example, a person unconsciously reacts to a certain bright level of video and another person unconsciously reacts to sound having a certain frequency level of the video.

Similar users may be determined on the basis of not patterns of time-series data blocks concerning biological reactions to a single content block but those concerning biological reactions to a plurality of content blocks.

The similar user specifying unit 23 outputs information concerning the similar users specified as described above to the recommended content specifying unit 24.

The recommended content specifying unit 24 refers to the respective users' evaluations and viewing histories indicated by the information blocks stored in the biological information DB 22 to specify a content block that the user of the client 1 has not experienced and is highly evaluated by a user specified to be similar to the user of the client 1. Specifying a recommended content block is performed when, for example, a content recommendation request is received from the client 1 at a predetermined time.

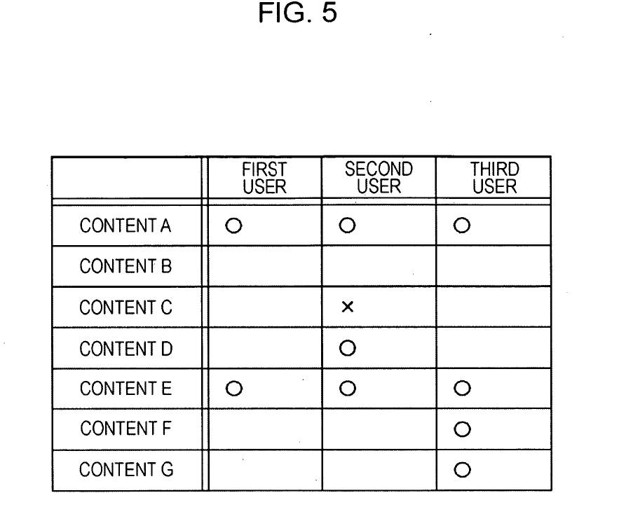

FIG. 5 is a diagram illustrating users' evaluations and viewing histories.

FIG. 5 illustrates the evaluations of content blocks A to G and viewing histories of the first to third users. It is assumed that the first user is the user of the client 1.

Referring to FIG. 5, each while circle represents a content block that the user has experienced and is given high evaluation and a cross represents a content block that the user has experienced and is given low evaluation. Each blank field represents a content block that the user has not experienced.

For example, the first user has viewed the content blocks A and E and has highly evaluated those content blocks. The second user has viewed the content blocks A, C, D, and E and has given high evaluation to the content blocks A, D, and E but has given low evaluation to the content C. The third user has viewed the content blocks A, E, F, and G and has highly evaluated those content blocks.

In the case where the above-described evaluations and viewing histories have been obtained, in the recommended content specifying unit 24, the second user is specified as a user similar to the first user, serving as the user of the client 1, on the basis of the information blocks (refer to FIG. 4) supplied from the similar user specifying unit 23.

Accordingly, the recommended content specifying unit 24 specifies, as recommended content, the content D that the first user has not experienced and is highly evaluated by the second user similar to the first user.

The content C that the first user has not experienced and the second user has given low evaluation and the content blocks F and G that the third user, who is not similar to the first user, has highly evaluated are not selected as recommended content.

The recommended content specifying unit 24 reads out information blocks respectively relating to the title of the recommended content, a summary thereof, and a distribution source from the content DB 25 and outputs the read-out information blocks to the transmitting unit 26. The content DB 25 stores various information blocks relating to content blocks.

The transmitting unit 26 transmits the information blocks supplied from the recommended content specifying unit 24 to the client 1.

Processes by the client 1 and the server 2 having the above-described structures will now be described below.

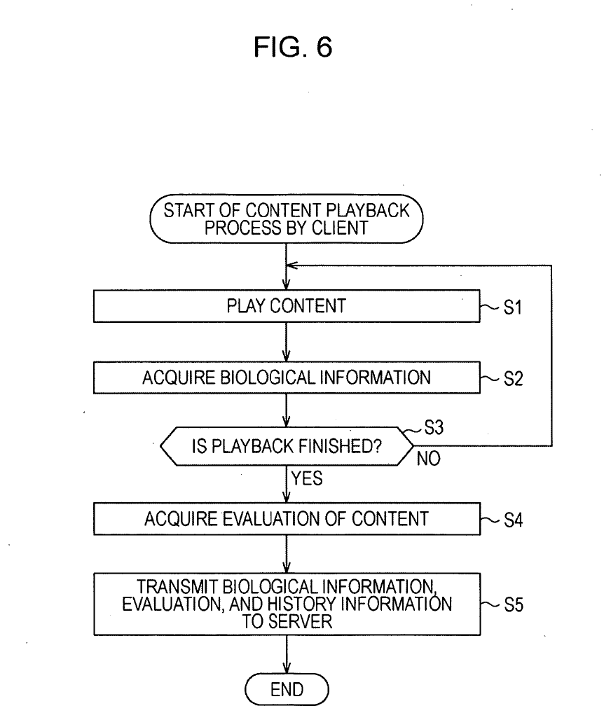

First, a content playback process by the client 1 will be described with reference to a flowchart of FIG. 6. This process is started when, for example, the user instructs the client 1 to play a predetermined content block.

In step S1, the biological information processing unit in the client 1 reads out the content from the content DB and plays the read-out content.

In step S2, the biological information acquiring unit acquires biological information, serving as time-series data concerning a biological reaction of the user viewing the content, on the basis of outputs from a measuring device on the user, and then outputs the biological information to the biological information processing unit 13.

In step S3, the biological information processing unit 13 determines whether playback of the content is finished. When the biological information processing unit 13 determines that it is not finished, the process is returned to step S1 and the above-described processing is repeated.

Whereas, when determining in step S3 that the playback of the content is finished, the biological information processing unit 13 acquires user's evaluation of the played content in step S4. The biological information processing unit 13 outputs the biological information, the evaluation of the content, and information concerning user's viewing history to the transmitting unit 14.

In step S5, the transmitting unit 14 transmits the information blocks supplied from the biological information processing unit 13 to the server 2. After that, the process is terminated.

In the above description, it is assumed that the user manually enters an evaluation of the content. A content block that the user has performed an operation for highly evaluating the content may be given high evaluation. For example, a content bock which has been played several times, a delete-protected content block, and a content block which has been subjected to dubbing may be given high evaluation.

A content block containing, as metadata, the same word as a keyword, such as the name of an actor, entered by a user upon retrieving content may be given high evaluation. Content blocks each contain various metadata blocks concerning the tile, a distribution source, the cast, and a summary.

Furthermore, if the user of the client 1 has been recommended a content block by the server 2, a content block containing the same metadata as that of the recommended content which the user of the client 1 has accepted and has performed an operation for purchasing or playing may be given high evaluation.

A content block which the user of the client 1 possesses by, for example, buying may be given high evaluation.

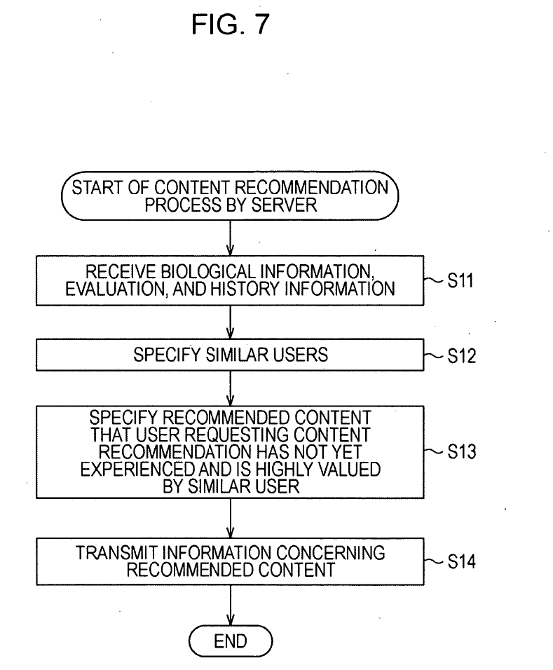

A content recommendation process by the server 2 will now be described with reference to a flowchart of FIG. 7.

In step S11, the receiving unit 21 in the server 2 receives biological information, an evaluation of a content block, and information concerning the user's viewing history transmitted from the client 1 and stores the received information blocks in the biological information DB 22.

This process is performed each time information blocks are transmitted from any of the terminals having the same structure as that of the client 1. Accordingly, the biological information DB 22 stores biological information blocks of respective users, evaluations of content blocks, and information blocks concerning viewing histories of the respective users.

In step S12, the similar user specifying unit 23 specifies similar users on the basis of the biological information blocks stored in the biological information DB 22. The similar user specifying unit 23 outputs information concerning the specified similar users to the recommended content specifying unit 24.

In step S13, the recommended content specifying unit 24 refers to the evaluations and viewing histories of the respective users and specifies, as recommended content, a content block that the user of the client 1 has not experienced and is highly evaluated by a user similar to the user of the client 1. The recommended content specifying unit 24 outputs information concerning the recommended content to the transmitting unit 26.

In step S14, the transmitting unit 26 transmits the information supplied from the recommended content specifying unit 24 to the client 1. The process is terminated.

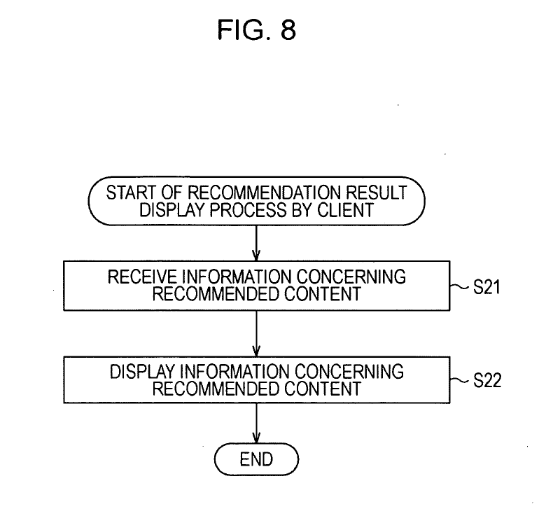

A recommendation result display process by the client 1 will now be described with reference to a flowchart of FIG. 8. This process is started when, for example, information concerning recommended content is transmitted from the server 2 in response to a request from the client 1.

In step S21, the receiving unit 15 in the client 1 receives information, concerning a recommended content block, transmitted from the server 2 and outputs the received information to the content recommending unit 16.

In step S22, the content recommending unit 16 displays the information concerning the recommended content specified by the server 2 on the television receiver 31 to present the recommended content to the user. The user operates the remote control so as to download and purchase the recommended content or view the content in streaming format. After that, the process is terminated.

According to the above-described processes, the server 2 can perform collaborative filtering using not users' conscious evaluations of content blocks but users' feelings about the content blocks and can recommend a content block.

In recommending a content block, the server 2 can use the similarity of content blocks which are difficult for users to explain. Accordingly, the server 2 can recommend content from a point of view different from that for recommendation based on evaluations.

In the above description, similar users are specified on the basis of patterns of time-series data blocks concerning biological reactions, and a content block highly evaluated by a similar user is specified as a content block recommended to another similar user. The same process may be performed on the basis of patterns of time-series data blocks concerning expressions of users during viewing content.

In this instance, expressions are user's reactions externally recognized using images and sounds. Such externally recognizable reactions include, for example, facial expression such as smiling or frowning, speech such as talking to oneself or conversation, an action such as clapping, jiggling the user's body part, or tapping, and a posture such as placing the user's elbow on, for example, his or her bent knee or inclining forwardly or backwardly. Since expressions are reactions of a user as a living body during viewing content, the above-described biological information may include information concerning expression.

During playback of a content block, the biological information acquiring unit 11 in the client 1 detects various expressions of a user at predetermined time intervals on the basis of images obtained by shooting the user viewing the content and user's sounds obtained by collecting sounds.

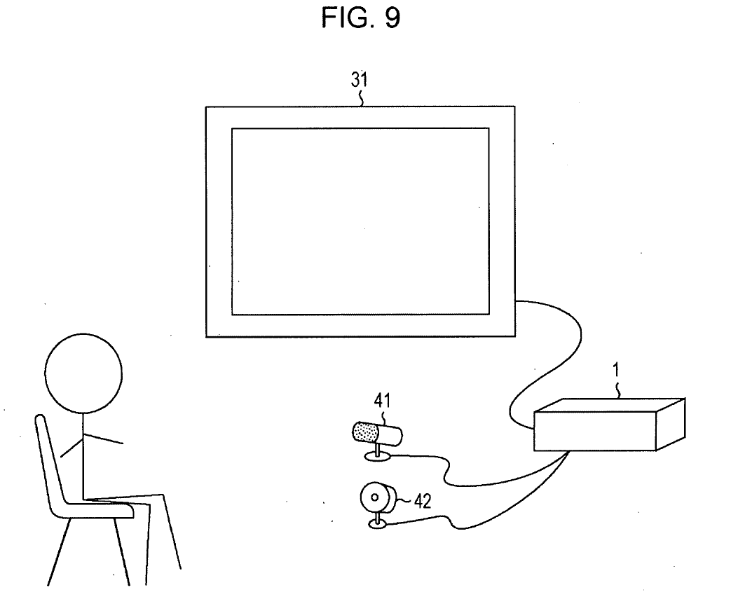

FIG. 9 is a diagram illustrating a situation where a content block is being played.

Referring to FIG. 9, a microphone 41 and a camera 42 are connected to the client 1 in addition to the television receiver 31. The microphone 41 and the camera 42 are aimed at the user of the client 1, the user sitting on the chair in front of the television receiver 31 and viewing the content.

User's sounds collected by the microphone 41 and images captured by the camera 42 during playback of the content are supplied to the client 1.

For example, the above-described smiling is detected in such a manner that segments including the face of the user (hereinafter, “face images”) are detected from the images captured through the camera 42, and matching is performed on features extracted from the detected face images using prepared smiling features. The biological information acquiring unit 11 acquires time-series data concerning the times when the user smiled and the degree of smiling (e.g., laughing and slightly smiling).

Similarly, frowning is detected in such a manner that face images are detected from the images captured through the camera 42 and matching is performed on features extracted from the detected face images using prepared frowning features. The biological information acquiring unit 11 acquires time-series data concerning the times when the user frowned and the degree of frowning.

As for speech, such as talking to oneself or conversation, speaker recognition is performed on sounds collected through the microphone 41 to specify a speaker. Whether a sound was collected when the user of the client 1 talked to himself or herself or when the user of the client 1 talked with a person viewing the content together with the user of the client 1 is determined, so that speech is detected. The biological information acquiring unit 11 acquires time-series data concerning the times when the user talked and the degree of speech, such as volume.

Clapping is detected on the basis of sounds collected through the microphone 41. The biological information acquiring unit 11 acquires time-series data concerning the times when the user clapped and the degree of clapping, such as the intensity of clapping.

Other expressions are similarly detected on the basis of data obtained through the microphone 41 and the camera 42. As for expression detection, data obtained through the microphone 41 and the camera 42 may be temporarily recorded onto a recording medium, such as a hard disk, and an expression may be detected from the recorded data. Alternatively, an expression may be detected in real time each time data is supplied from the microphone 41 and the camera 42.

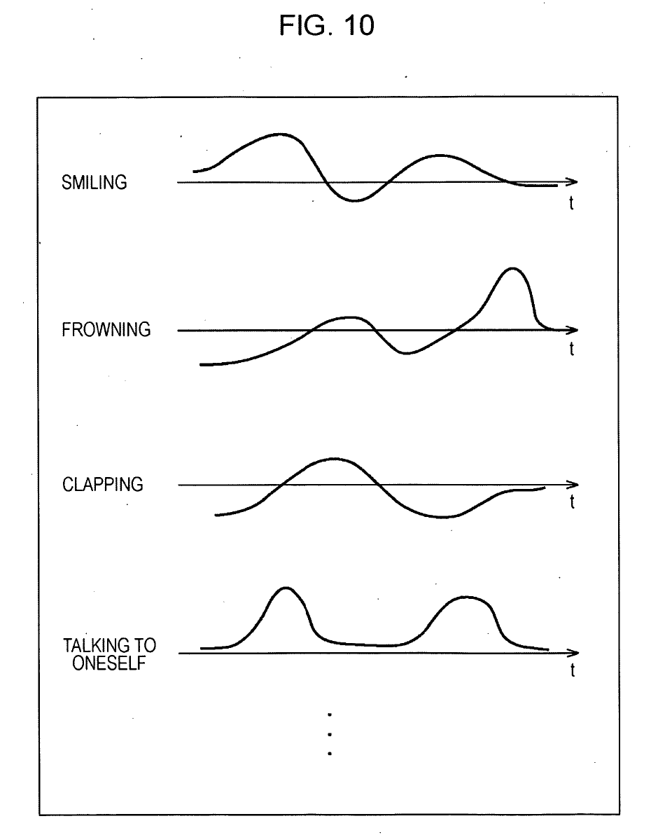

FIG. 10 shows examples of time-series data blocks concerning expressions.

Referring to FIG. 10, the time-series data blocks concerning smiling, frowning, clapping, and taking to oneself are shown in order from the top. FIG. 10 shows the degree plotted against time.

The biological information acquiring unit 11 outputs the time-series data blocks concerning the expressions detected as described above to the biological information processing unit 13. In the client 1, a plurality of content blocks are played, and time-series data blocks as shown in FIG. 10 are obtained for each played content block.

The client 1 transmits the time-series data blocks concerning the expressions together with the user's evaluations of the content blocks and the information concerning the user's viewing history to the server 2. The other terminals having the same structure as that of the client 1 similarly transmit data blocks concerning the expressions to the server 2. Accordingly, the server 2 acquires the data blocks concerning the expressions of the users.

The server 2 compares patterns of the time-series data blocks concerning the same expression relating to the same content block to specify similar patterns having similar portions where the target expression has been detected and similar degrees, i.e., similar users who have similar patterns of the time-series data blocks.

After the similar users are specified, a content block which the user of the client 1 has not experienced and is highly evaluated by a user similar to the user of the client 1 is specified as recommended content. Information concerning the recommended content is transmitted to the client 1.

A certain user laughs many times during viewing content that the user feels interesting. Another user claps many times during viewing content that the user feels interesting. In other words, it is estimated that expressions during viewing content vary from user to user. Accordingly, similar users having similar ways of viewing can be specified using patterns of time-series data blocks concerning expressions.

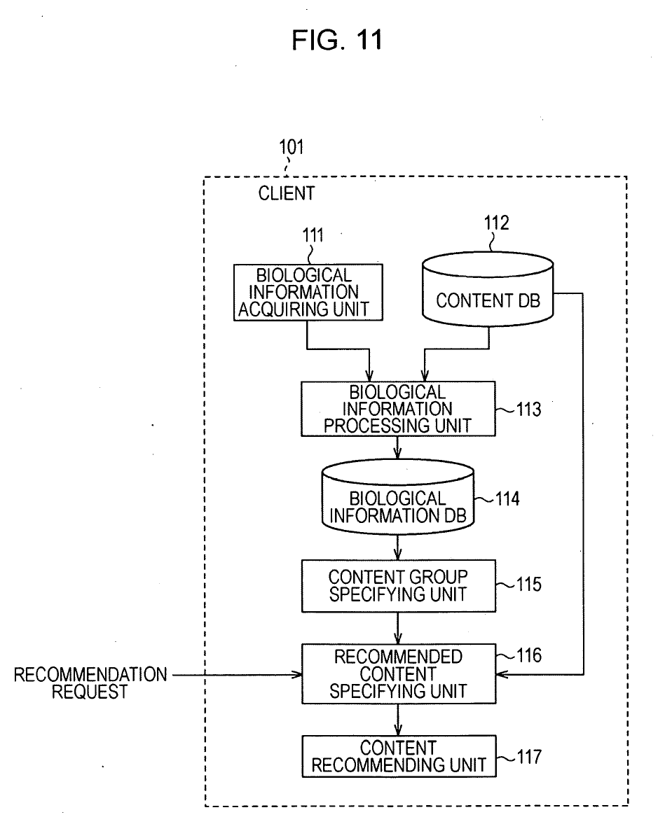

FIG. 11 is a block diagram illustrating the structure of a content recommendation system according to another embodiment of the present invention.

Referring to FIG. 11, this content recommendation system is realized by a client 101.

The client 101 includes a biological information acquiring unit 111, a content DB 112, a biological information processing unit 113, a biological information DB 114, a content group specifying unit 115, a recommended content specifying unit 116, and a content recommending unit 117.

As will be described in detail below, in the client 101, a group of content blocks to which a viewing or listening user has similar biological reactions is specified. In addition, when a request to recommend a content block similar to a certain content block is received, a content block belonging to the same group as that to which a reference content block belongs is recommended.

A biological reaction includes the hemoglobin content of blood, blood flow, perspiration rate, or pulse. Any reaction exhibited by a user viewing or listening to a content block may be used as a biological reaction.

The biological information acquiring unit 111 in the client 101 acquires biological information, serving as time-series data concerning a biological reaction of a user viewing a content block in a situation shown in FIG. 2 during playback of the content. The biological information acquiring unit 111 outputs the acquired biological information to the biological information processing unit 113. The biological information also contains information about which content block was played to acquire the biological information.

In the client 101, a plurality of content blocks are played. Biological information blocks, each serving as time-series data as shown in FIG. 3, are acquired for the respective played content blocks.

The biological information processing unit 113 reads out a content block stored in the content DB 112 and plays the read-out content. The biological information processing unit 113 acquires biological information sequentially supplied from the biological information acquiring unit 111 during playback of the content and stores the acquired biological information in the biological information DB 114. Since a plurality of content blocks are played, the biological information DB 114 stores biological information blocks of the user of the client 101 relating to the respective played content blocks.

The content group specifying unit 115 specifies a group of content blocks to which the user has similar biological reactions during viewing on the basis of patterns of time-series data blocks concerning the biological reactions indicated by the biological information blocks stored in the biological information DB 114.

Whether the patterns of the time-series data blocks concerning the biological reactions are similar is determined by, for example, obtaining the cross-correlation between the patterns of the time-series data blocks, obtaining the degree of agreement between each pattern and a specific pattern, or obtaining the degree of agreement between each pattern in a specific portion and a threshold.

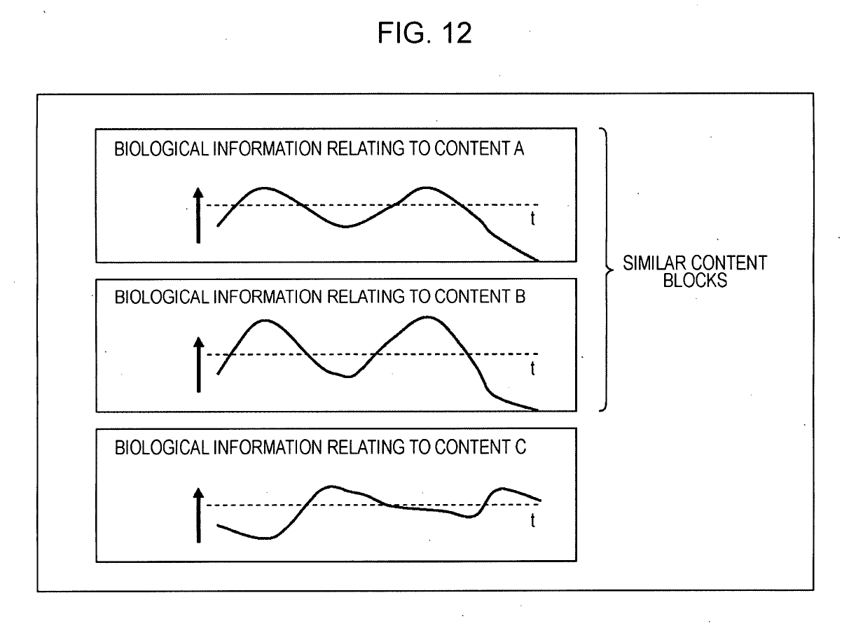

FIG. 12 shows examples of biological information blocks of the user of the client 101.

Referring to FIG. 12, patterns of time-series data blocks concerning the biological information blocks relating to content blocks A to C are shown in order from the top.

In the case where the patterns of the time-series data blocks concerning the user's biological reactions to the content blocks A to C are obtained as shown in FIG. 12, the pattern of the time-series data concerning the biological reaction to the content A is similar to that concerning the biological reaction to the content B. Accordingly, the content blocks A and B belong to a group of similar content blocks to which the user of the client 101 has similar biological reactions during viewing.

In both of the content A and the content B, the user exhibits similar degrees of biological reactions to scenes played after similar intervals of time from the start of viewing.

The above-described hemoglobin content of blood used as a biological reaction represents brain activity. It is estimated that the brain activity of the user varies depending on the user's feeling during viewing a content block. Accordingly, similar content blocks have similar features at similar timings. In other words, the similar content blocks allow the user to have a similar way of viewing.

The content group specifying unit 115 outputs information concerning the group of similar content blocks specified as described above to the recommended content specifying unit 116.

When receiving a content recommendation request from the user, the recommended content specifying unit 116 refers to the information supplied from the content group specifying unit 115 and specifies, as recommended content, a content block belonging to the same similar content group as that to which a reference content block belongs.

For example, while viewing a certain content block, the user operates a remote control or a mouse to input an instruction to find out a content block similar to the content which the user is viewing, thus issuing a content recommendation request to the client 101. The client 101 specifies a content block to be recommended using the content which the user is viewing as a reference content block.

It is assumed that the similar content group is specified on the basis of the biological information blocks shown in FIG. 12. When the user requests to recommend similar content while viewing, for example, the content B, the content A belonging to the same similar content group as that to which the content B, serving as reference, belongs is specified as recommended content.

The recommended content specifying unit 116 reads out information blocks, relating to the title of the recommended content, a summary thereof, and a distribution source, from the content DB 112 and outputs the read-out information blocks to the content recommending unit 117.

The content recommending unit 117 displays the information blocks relating to the recommended content on the television receiver on the basis of the information blocks supplied from the recommended content specifying unit 116 to present the recommended content to the user.

Processes by the client 101 having the above-described structure will now be described.

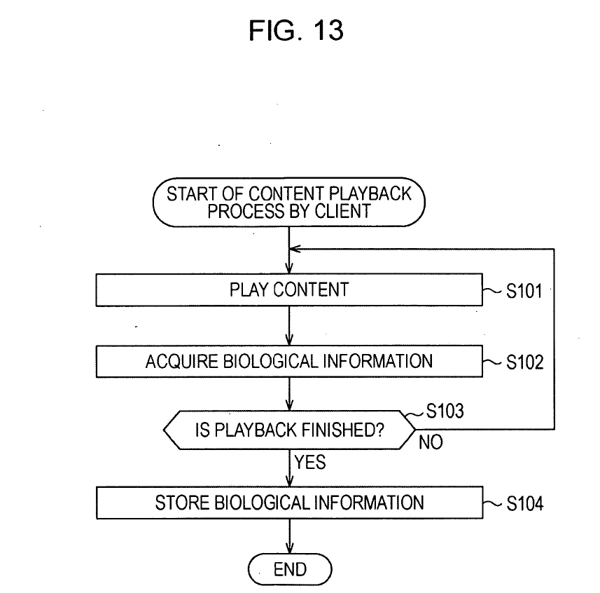

A content playback process by the client 101 will first be described with reference to a flowchart of FIG. 13. This process is started when, for example, the user instructs to play a predetermined content block.

In step S101, the biological information processing unit 113 in the client 101 plays the content read from the content DB 112.

In step S102, the biological information acquiring unit 111 acquires biological information, serving as time-series data concerning a biological reaction of the user viewing the content, on the basis of outputs from a measuring device on the user and then outputs the biological information to the biological information processing unit 113.

In step S103, the biological information processing unit 113 determines whether playback of the content is finished. When the biological information processing unit 113 determines that the playback is not finished, the process is returned to step S101. The above-described processing is repeated.

Whereas, when the biological information processing unit 113 determines in step S103 that the playback of the content is finished, the biological information processing unit 113 stores the biological information in the biological information DB 114 in step S104. After that, the process is terminated.

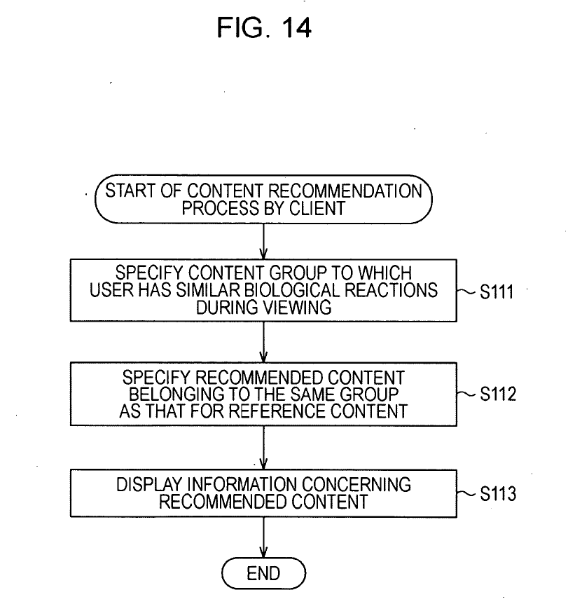

A content recommendation process by the client 101 will now be described with reference to a flowchart of FIG. 14.

In step S111, the content group specifying unit 115 specifies a group of similar content blocks, to which the user has similar biological reactions during viewing, on the basis of the biological information blocks stored in the biological information DB 114.

When receiving a content recommendation request from the user, the recommended content specifying unit 116 specifies, as recommended content, a content block belonging to the same similar content group as that to which a reference content block belongs in step S112.

In step S113, the content recommending unit 117 displays information concerning the recommended content to present the recommended content to the user. After that, the process is terminated.

According to the above-described processes, the client 101 can specify a recommended content block on the basis of the user's way of viewing to recommend the specified content.

To specify a group of content blocks to which the user has similar biological reactions during viewing and recommend a content block as described above, the client 101 has to allow the user to actually view many content blocks and acquire biological information blocks relating to the content blocks. For example, when the user has viewed three content blocks, the client 101 selects a recommended content block from among the three content blocks.

If the number of biological information blocks is small and it is difficult to appropriately recommend a content block, biological information blocks of another user may be acquired from another apparatus and a content block may be recommended using the acquired biological information blocks.

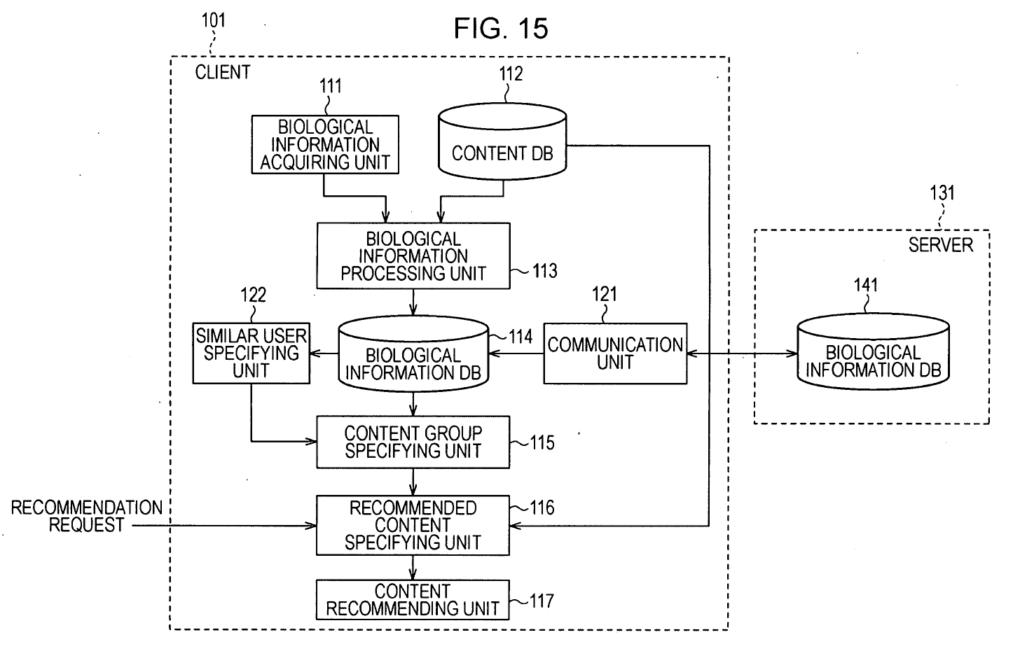

FIG. 15 is a block diagram illustrating the structure of a content recommendation system according to another embodiment of the present invention. In FIG. 15, the same components as those in FIG. 11 are designated by the same reference numerals. Explanation of the previously described components is omitted appropriately.

Referring to FIG. 15, the content recommendation system includes a client 101 and a server 131 such that the client 101 is connected to the server 131 via a network, such as the Internet.

The server 131 receives biological information blocks transmitted from a plurality of terminals having the same structure as that of the client 101, stores the received information blocks in a biological information DB 141, and manages the stored information blocks. Each biological information block also contains information about which content block was played to acquire the biological information block.

The client 101 in FIG. 15 differs from that in FIG. 11 in that the client 101 further includes a communication unit 121 and a similar user specifying unit 122.

The communication unit 121 communicates with the server 131 to acquire the biological information blocks of the users other than the user of the client 101 from the biological information DB 141. The communication unit 121 stores the acquires biological information blocks in a biological information DB 114.

The similar user specifying unit 122 specifies a similar user who has a biological reaction similar to that of the user of the client 101 during viewing the same content block on the basis of the biological information blocks stored in the biological information DB 114.

Specifically, the similar user specifying unit 122 compares a pattern of time-series data concerning the biological reaction of the user of the client 101 to a certain content block with those concerning the biological reactions of the other users to the same content block in a manner similar to the similar user specifying unit 23 in FIG. 1, thus specifying a similar user.

The similar user specifying unit 122 outputs information about which user is similar to the user of the client 101 to a content group specifying unit 115.

The content group specifying unit 115 reads out the biological information blocks of the user of the client 101 and those of the similar user from the biological information DB 114 and specifies a group of content blocks to which the users have similar biological reactions during viewing on the basis of the patterns of the time-series data blocks indicated by the read-out biological information blocks.

Since the user of the client 101 and the similar user have similar biological reactions to the same content block during viewing, the user of the client 101 will exhibit a biological reaction similar to that of the similar user during viewing a content block that the user of the client 101 has not viewed. Accordingly, a group of content blocks as described above are specified using the biological information blocks of the similar user as those of the user of the client 101.

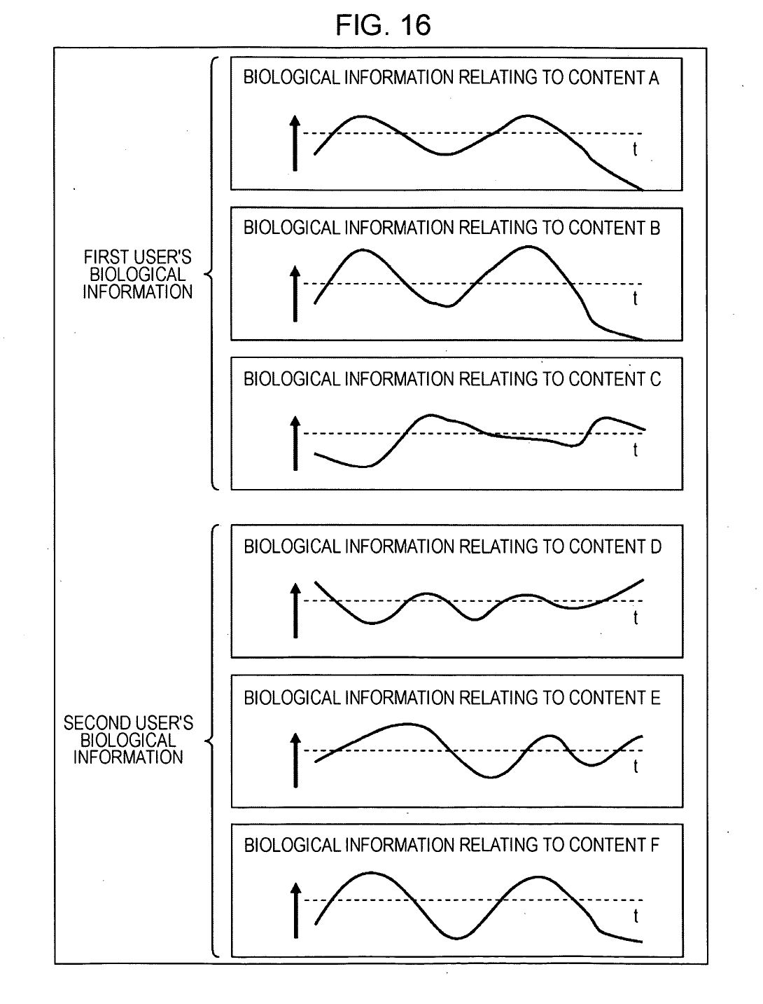

FIG. 16 shows examples of biological information blocks of a first user, serving as the user of the client 101, and those of a second user, serving as the similar user.

In FIG. 16, patterns of time-series data blocks concerning biological reactions to content blocks A to F are shown in order from the top.

The patterns of the time-series data blocks concerning the biological reactions to the content blocks A to C are indicated by biological information blocks acquired when the first user has actually viewed the content blocks A to C. The patterns of the time-series data blocks concerning the biological reactions to the content blocks D to F are indicated by biological information blocks of the second user acquired from the server 131.

In this case, the patterns of the time-series data blocks concerning the first user's biological reactions to the content blocks A and B are similar to the pattern of the time-series data concerning the second user's biological reaction to the content F. Accordingly, the content blocks A, B, and F belong to a group of similar content blocks.

The content group specifying unit 115 outputs information about the similar content group specified in this manner to a recommended content specifying unit 116. The recommended content specifying unit 116 selects, as recommended content, a content block belonging to the same similar content group as that to which a reference content block belongs.

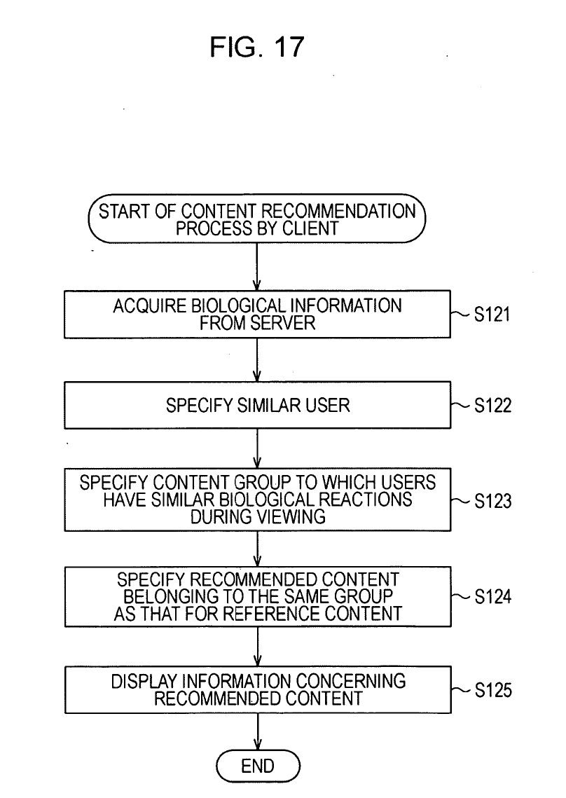

A process by the client 101 having the structure shown in FIG. 15 will now be described with reference to a flowchart of FIG. 17.

In step S121, the communication unit 121 communicates with the server 131 to acquire the biological information blocks of the users other than the user of the client 101.

In step S122, the similar user specifying unit 122 specifies a similar user on the basis of biological information of the user of the client 101 and biological information blocks of the other users acquired through the communication unit 121.

Processing in steps following step S123 is the same as that in steps following step S111 in FIG. 14. In step S123, the content group specifying unit 115 specifies a similar content group on the basis of patterns of time-series data blocks concerning biological reactions of the user of the client 101 and those of the specified similar user.

When receiving a content recommendation request from the user, the recommended content specifying unit 116 specifies as recommended content a content block belonging to the same similar content group as that to which a reference content block belongs in step S124.

In step S125, the content recommending unit 117 displays information relating to the recommended content to present the recommended content to the user. After that, the process is terminated.

According to the above process, even when there is not enough biological information of the user of the client 101, the client 101 can appropriately recommend a content block.

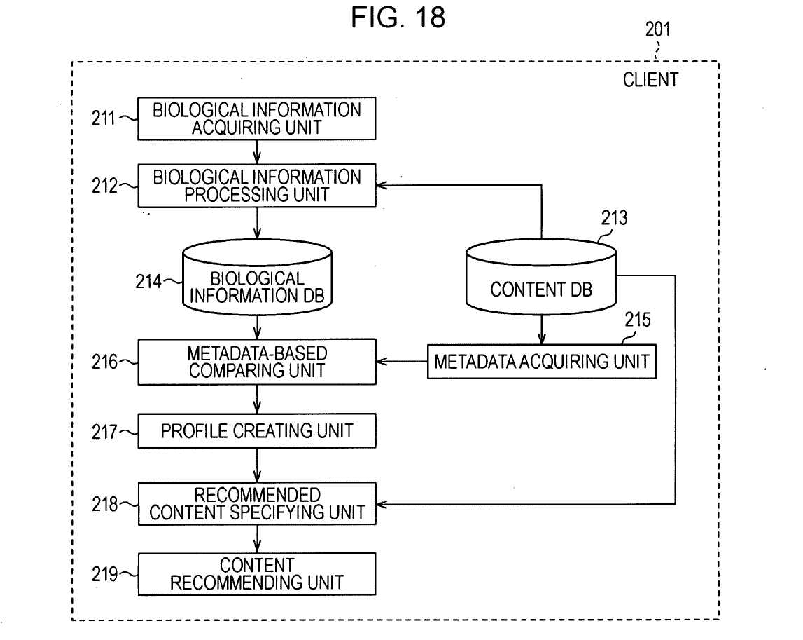

FIG. 18 is a block diagram illustrating the structure of a content recommendation system according to another embodiment of the present invention.

Referring to FIG. 18, the content recommendation system is realized by a client 201.

The client 201 includes a biological information acquiring unit 211, a biological information processing unit 212, a content DB 213, a biological information DB 214, a metadata acquiring unit 215, a metadata-based comparing unit 216, a profile creating unit 217, a recommended content specifying unit 218, and a content recommending unit 219.

As will be described in detail below, in the client 201, attribute values that a user of the client 201 does not need to distinguish from other various attribute values added as metadata to content are specified on the basis of biological information. In addition, the specified attribute values are merged to recreate a profile, and a content block is recommended on the basis of the recreated profile and metadata added to content.

In other words, the client 201 is an apparatus that performs content based filtering (CBF) as filtering based on the contents of content.

Assuming that target content is music content, the attributes of a content block are items used to represent features of the content, e.g., a genre, a tempo, a rhythm, with or without lyrics, the name of a singer, and the name of a composer.

Attribute values are set for the respective items. For example, “country music”, “jazz”, “pop music”, and “classical music” are set as genre attribute values.

A profile is information obtained by analyzing metadata of content that the user has actually viewed or listened to. For example, a profile contains information indicating that the user has listened to music content, of which the genre is “country music”, 10 times and information indicating that the user has listened to music content, of which the genre is “pop music”, 10 times.

In the content DB 213 included in the client 201, stored content blocks have various attribute values as metadata blocks.

The profile creating unit 217 manages the profile of the user of the client 201. The profile managed by the profile creating unit 217 is updated each time the user performs an operation on a content block, e.g., views or listens to, or dubs the content.

During playback of a content block, such as a piece of music, the biological information acquiring unit 211 of the client 201 acquires biological information, serving as time-series data concerning a biological reaction of the user listening to the content.

The biological reaction includes the hemoglobin content of blood, blood flow, perspiration rate, or pulse. Any reaction exhibited by the user viewing or listening to a content block may be used as a biological reaction.

The biological information acquiring unit 211 outputs the biological information to the biological information processing unit 212. In the client 201, a plurality of content blocks are played by attribute value as metadata. Biological information blocks, each serving as time-series data as shown in FIG. 3, are acquired for the respective played content blocks.

The biological information processing unit 212 reads out a content block stored in the content DB 213 and plays the content. The biological information processing unit 212 acquires biological information sequentially supplied from the biological information acquiring unit 211 during playback of the content and stores the biological information in the biological information DB 214. Since a plurality of content blocks are played, the biological information DB 214 stores biological information blocks of the user of the client 201 relating to the played content blocks.

The metadata acquiring unit 215 reads out metadata blocks of content blocks which have been played to acquire biological information and outputs the read-out metadata blocks to the metadata-based comparing unit 216. The content DB 213 stores various information blocks concerning content blocks. The metadata acquiring unit 215 may acquire metadata from a server that manages metadata blocks of content blocks.

The metadata-based comparing unit 216 compares patterns of time-series data blocks concerning biological reactions to content blocks with different attribute values to specify a characteristic pattern specific to each attribute value. When the extracted patterns relating to different attribute values are similar, the metadata-based comparing unit 216 learns the different attribute values, which the user of the client 201 does not need to distinguish those attribute values, such that those attribute values are treated as the same value.

Specifically, the metadata-based comparing unit 216 specifies an attribute deeply linked to biological information on the basis of the biological information blocks stored in the biological information DB 214 and the metadata blocks supplied from the metadata acquiring unit 215. Subsequently, the metadata-based comparing unit 216 specifies attribute values that are set as values of the specified attribute and that the user of the client 201 does not need to distinguish.

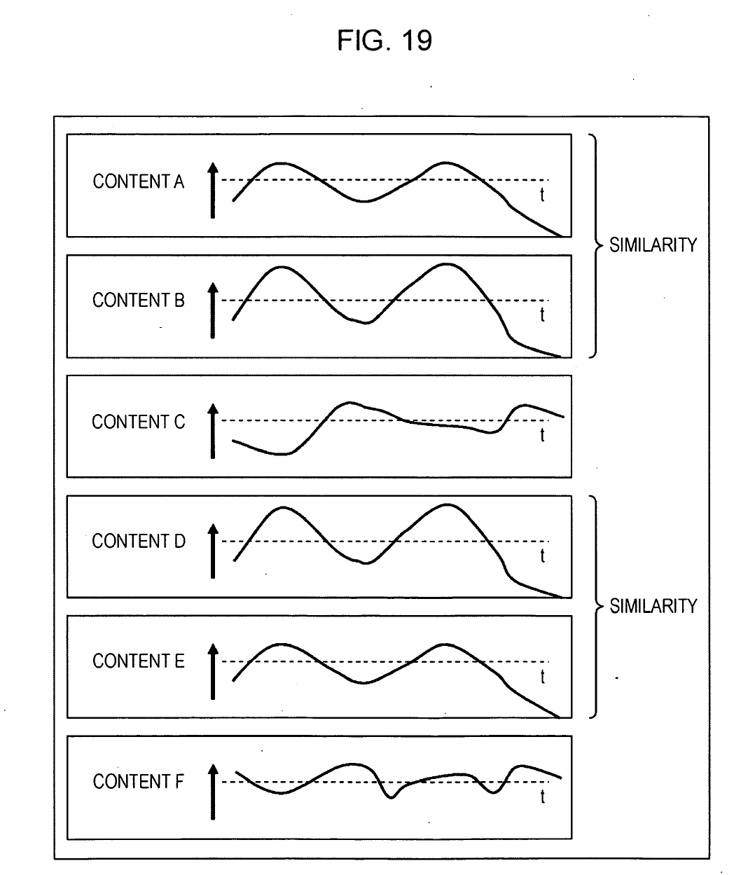

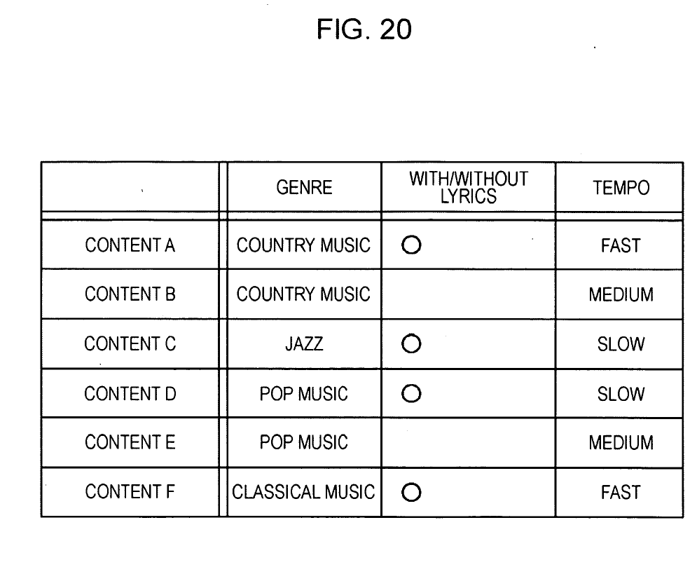

How to specify attribute values that the user of the client 201 does not need to distinguish will now be described with reference to FIGS. 19 and 20.

FIG. 19 shows examples of biological information blocks of the user of the client 201.

In FIG. 19, patterns of time-series data blocks concerning biological reactions to content blocks A to F are shown in order from the top. The patterns of the time-series data blocks concerning the biological reactions to the content blocks A, B, D, and E are similar to one another.

The metadata-based comparing unit 216 determines which content blocks have similar patterns of the time-series data blocks concerning the biological reactions by, for example, obtaining the cross-correlation between the patterns of the time-series data blocks, obtaining the degree of agreement between each pattern and a specific pattern, or obtaining the degree of agreement between each pattern in a specific portion and a threshold.

FIG. 20 is a diagram illustrating examples of metadata blocks of the content blocks A to F.

Referring to FIG. 20, values of respective attributes representing “genre”, “with/without lyrics”, and “tempo” are shown. As for the content A, the genre is “country music”, the content A is “with lyrics”, and the tempo is “fast”. As for attribute values representing “with/without lyrics”, each white circle represents “with lyrics” and each blank field represents “without lyrics”.

Similarly, as for the content B, the genre is “country music”, the content B is “without lyrics”, and the tempo is “medium”. Regarding the content C, the genre is “jazz”, the content B is “with lyrics”, and the tempo is “slow”. As for the content D, the genre is “pop music”, the content D is “with lyrics”, and the tempo is “slow”. Regarding the content E, the genre is “pop music”, the content E is “without lyrics”, and the tempo is “medium”. As for the content F, the genre is “classical music”, the content F is “with lyrics”, and the tempo is “fast”.

Assuming that the above-described biological information blocks and metadata blocks are acquired, the metadata-based comparing unit 216 compares the patterns of the time-series data blocks concerning the biological reactions to specify the attribute representing “genre” as an attribute deeply linked to the biological information blocks.

If the attribute representing “with/without lyrics” is deeply linked to the biological information blocks, the pattern of the time-series data concerning the biological reaction to the content A having the attribute value representing “with lyrics” should not be similar to that to the content B having the attribute value representing “without lyrics”. However, the patterns of the time-series data blocks concerning the biological reactions to those content blocks are similar as shown in FIG. 19.

In addition, the pattern of the time-series data concerning the biological reaction to the content A having the attribute value representing “with lyrics” should be similar to that to the content C similarly having the attribute value representing “with lyrics”. However, the patterns of the time-series data blocks concerning the biological reactions to those content blocks are not similar as shown in FIG. 19.

Consequently, the attribute representing “with/without lyrics” is not deeply linked to the biological information blocks.

Similarly, if the attribute representing “tempo” is deeply linked to the biological information blocks, for example, the pattern of the time-series data concerning the biological reaction to the content A having the attribute value representing “fast tempo” should not be similar to that to the content D having the attribute value representing “slow tempo”. However, the patterns of the time-series data blocks concerning the biological reactions to those content blocks are similar as shown in FIG. 19.

In addition, the pattern of the time-series data concerning the biological reaction to the content A having the attribute value representing “fast tempo” should be similar to that to the content F having the attribute value representing “fast tempo”. However, the patterns of the time-series data blocks concerning the biological reactions to those content blocks are not similar as shown in FIG. 19.

Therefore, the attribute representing “tempo” is also not deeply linked to the biological information blocks.

Regarding the attribute representing “genre”, for example, the pattern of the time-series data concerning the biological reaction to the content A having the attribute value representing “country music” as a genre is similar to that to the content B having the same attribute value representing “country music” as shown in FIG. 19.

In addition, the pattern of the time-series data concerning the biological reaction to the content D having the attribute value representing “pop music” as a genre is similar to that to the content E having the same attribute value representing “pop music” as shown in FIG. 19.

The pattern of the time-series data concerning the biological reaction to the content A having the genre attribute value representing “country music” is not similar to that to the content C having the genre attribute value representing “jazz” as shown in FIG. 19.

Accordingly, the set values of the attribute representing “genre” affect the biological information blocks. It is found that the genre attribute values are deeply linked to the biological information blocks.

Since the biological information blocks represent a way of viewing or listening to content, the user of the client 201 will have different ways of viewing or listening to content blocks of different genres and have the same way of viewing or listening to content blocks of the same genre.

After specifying the attribute deeply linked to the biological information blocks, the metadata-based comparing unit 216 specifies attribute values that are set as values of the attribute deeply linked to the biological information blocks and that the user of the client 201 does not need to distinguish.

In the case where the biological information blocks in FIG. 19 and the metadata blocks in FIG. 20 are acquired, the attribute values representing “country music” and “pop music” set as values of the genre attribute deeply linked to the biological information blocks are specified as attribute values that the user of the client 201 does not need to distinguish.

As described above, the biological information blocks represent a way of viewing or listening to content. The user of the client 201 should have different ways of viewing or listening to content blocks of different genres and have the same way of viewing or listening to content blocks of the same genre.

The content blocks A and B belong to the genre “country music” and the content blocks D and E belong to the genre “pop music”. Accordingly, since the content blocks A and B are different from the content blocks D and E in genre, the user of the client 201 should have different ways of listening to those content blocks and the patterns of the time-series data blocks concerning the biological reactions should be detected as different patterns. However, the patterns of the time-series data blocks concerning the biological reactions to the content blocks A and B are similar to those to the content blocks D and E as shown in FIG. 19.

This means that the user of the client 201 listens to the content blocks of the genre “country music” and those of the genre “pop music” such that the user does not distinguish between those genres. It is therefore useless for the user of the client 201 to set “country music” and “pop music” as different genre attribute values.

The metadata-based comparing unit 216 specifies “country music” and “pop music” as attribute values that the user of the client 201 does not need to distinguish and outputs information concerning the specified attribute values to the profile creating unit 217.

As a matter of course, not only two attribute values “country music” and “pop music” but also more attribute values may be specified as attribute values that do not need to be distinguished depending on patterns of time-series data blocks concerning biological reactions.

When a plurality of users share the client 201, acquiring biological information and specifying attribute values that do not need to be distinguished in the above-described manner are performed for each user.

The profile creating unit 217 merges the attribute values, which the user of the client 201 does not need to distinguish, specified as the same attribute value through the metadata-based comparing unit 216 to recreate a profile.

In the case where it is unnecessary to distinguish the attribute values representing “country music” and “pop music”, assuming that information indicating that the user has listened to “country music” content 10 times and information indicating that the user has listened to “pop music” content 10 times are contained in the profile before recreation, the profile creating unit 217 combines those information blocks into information indicating that the user has listened to “country music/pop music” content 20 times to recreate the profile.

The profile creating unit 217 outputs the recreated profile to the recommended content specifying unit 218.

The recommended content specifying unit 218 specifies a recommended content block on the basis of the profile recreated by the profile creating unit 217.

For example, assuming that the profile contains information indicating that the user has listened to “jazz” content 15 times in addition to the information indicating that the user has listened to “country music/pop music” content 20 times, the recommended content specifying unit 218 recognizes that the user of the client 201 prefers “country music” content and “pop music” content to “jazz” content, thus specifying a “country music” content block or a “pop music” content block as recommended content.

If profile recreation is not performed, the profile contains the information indicating that the user has listened to “country music” content 10 times and the information indicating that the user has listened to “pop music” content 10 times such that those information blocks are separated from each other. Unfortunately, it is not recognized that the user of the client 201 prefers “country music” content and “pop music” content to “jazz” content.

The user of the client 201 does not distinguish “country music” content and “pop music” content. Accordingly, if the user has listened to content of each genre 10 times, it is clear in terms of the total number of listening times that the user prefers “country music” content and “pop music” content to “jazz” content.

The recommended content specifying unit 218 reads out information blocks concerning the title of a recommended content block, a summary thereof, and a distribution source from the content DB 213 and outputs the read-out information blocks to the content recommending unit 219. The content DB 213 stores various information blocks relating to content blocks.

The content recommending unit 219 displays information concerning the recommended content on the basis of the information blocks supplied from the recommended content specifying unit 218 to present the recommended content.

Processes by the client 201 having the above-described structure will now be described.

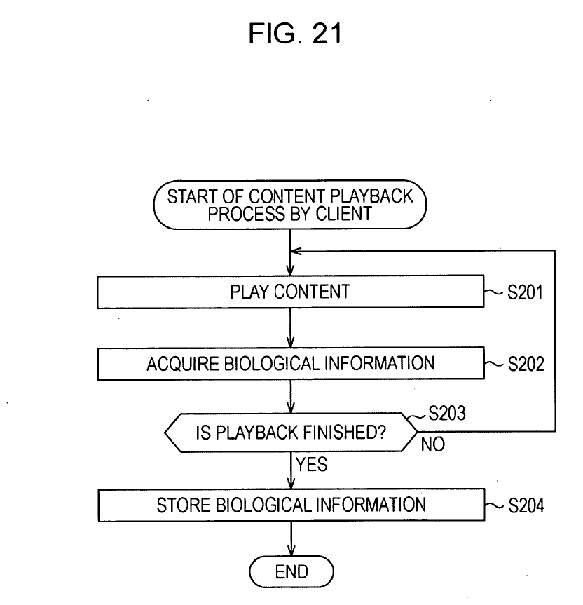

A content playback process by the client 201 will first be described with reference to a flowchart of FIG. 21. This process is started when, for example, the user gives an instruction to play a predetermined content block.

In step S201, the biological information processing unit 212 in the client 201 plays a content block read from the content DB 213.

In step S202, the biological information acquiring unit 211 acquires biological information, serving as time-series data concerning a biological reaction of the user viewing the content, on the basis of outputs of a measuring device on the user and then outputs the biological information to the biological information processing unit 212.

In step S203, the biological information processing unit 212 determines whether playback of the content is finished. When the biological information processing unit 212 determines that the playback is not finished, the process is returned to step S201. The above-described processing is repeated.

Whereas, when the biological information processing unit 212 determines in step S203 that the playback is finished, the biological information processing unit 212 stores the biological information in the biological information DB 214 in step S204. After that, the process is terminated.

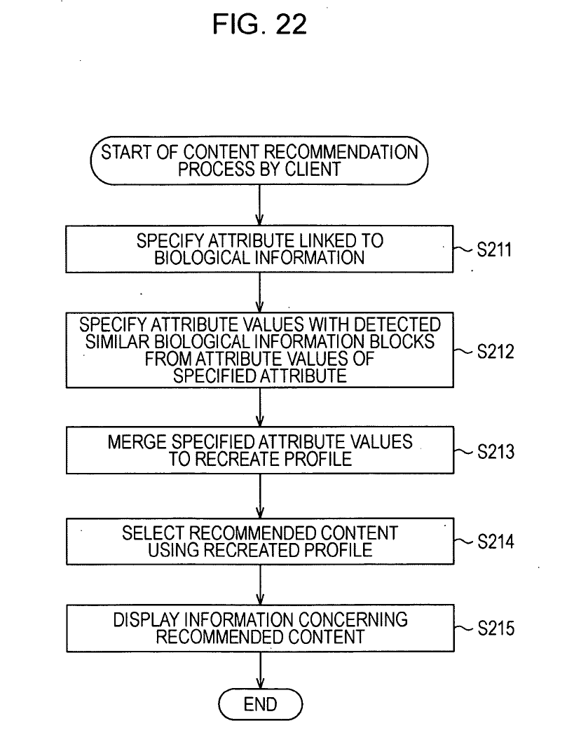

A content recommendation process by the client 201 will now be described with reference to a flowchart of FIG. 22.

In step S211, the metadata-based comparing unit 216 specifies an attribute deeply linked to biological information blocks on the basis of the biological information blocks stored in the biological information DB 214 and metadata blocks supplied from the metadata acquiring unit 215 in the above-described manner.

In step S212, the metadata-based comparing unit 216 specifies attribute values, included in set attribute values of the specified attribute, having similar patterns of time-series data blocks concerning biological reactions as attribute values that the user of the client 201 does not need to distinguish.

In step S213, the profile creating unit 217 merges the attribute values, which the metadata-based comparing unit 216 specifies and the user of the client 201 does not need to distinguish, to recreate a profile.

In step S214, the recommended content specifying unit 218 specifies a recommended content block on the basis of the profile recreated by the profile creating unit 217.

In step S215, the content recommending unit 219 displays information concerning the recommended content to present the recommended content to the user. After that, the process is terminated.

According to the above-described processes, the client 201 can treat attribute values that the user does not distinguish as the same attribute value to create a profile and recommend a content block on the basis of the profile.

The content DB 213 and the biological information DB 214 may be disposed in a server connected to the client 201 via a network.

In addition, user expression may be recognized while the user is viewing a content block, and the relationship between a specific expression, such as smiling, and metadata set in a scene of the content played upon appearance of the specific expression may be learned. Consequently, when the specific expression is detected using CBF, a broadcast program scene whereby the same expression will appear can be retrieved or recommended.

The above-described series of processing steps can be executed by hardware or software. When the above-described series of processing steps is executed by software, a program constituting the software is installed from a program recording medium into a computer incorporated in dedicated hardware or into a multi-purpose personal computer which is capable of executing various functions by installing various programs.

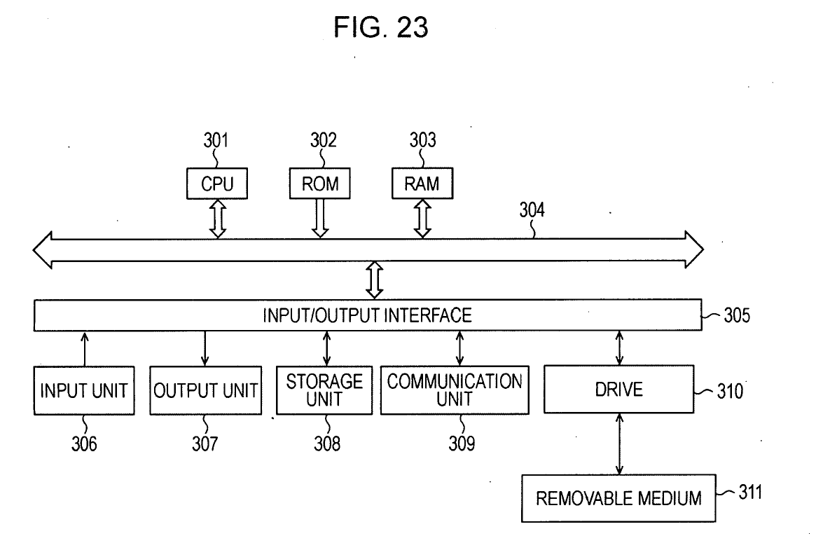

FIG. 23 is a block diagram of the structure of a computer for executing the above-described series of processing steps in accordance with a program.

At least part of the structure of each of the client 1 and the server 2 in FIG. 1, the clients 101 in FIGS. 11 and 15, the server 131 in FIG. 15, and the client 201 in FIG. 18 is realized by executing a predetermined program through a central processing unit (CPU) 301 in the computer with the structure shown in FIG. 23.

The CPU 301, a read only memory (ROM) 302, and a random access memory (RAM) 303 are connected to a bus 304 such that they are connected to one another.

The bus 304 is further connected to an input/output interface 305. The input/output interface 305 is connected to an input unit 306 including a keyboard, a mouse, and a microphone, an output unit 307 including a display and a speaker, a storage unit 308 including a hard disk and a nonvolatile memory, a communication unit 309 including a network interface, and a drive 310 that drives a removable medium 311, such as an optical disk or a semiconductor memory.

In the computer with the above-described structure, the CPU 301 loads a program stored in, for example, the storage unit 308 into the RAM 303 through the input/output interface 305 and the bus 304 and executes the program, thereby performing the above-described series of processing steps.

As for a program to be executed by the CPU 301, the program recorded on, for example, the removable medium 311 may be provided. Alternatively, the program may be provided through a wired or wireless transmission medium, such as a local area network, the Internet, or digital satellite broadcasting. The provided program is installed in the storage unit 308.

The program executed by the computer may be a program including processing steps which are carried out in time series in the described order in this specification or a program including processing steps which are carried out in parallel or individually at necessary timing, for example, in response to a call request.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing terminal comprising:
acquiring means for acquiring biological information concerning a biological reaction of a user to each content block during playback of the content block;
group specifying means for specifying a group of content blocks, to which the user has similar biological reactions during playback, on the basis of the biological information acquired through the acquiring means;
recommended content specifying means for specifying as recommended content a content block belonging to the same group as that to which a reference content block belongs; and
recommending means for presenting information concerning the recommended content specified by the recommended content specifying means to the user.

2. The terminal according to claim 1, wherein the information processing terminal is connected via a network to an information processing apparatus that acquires biological information blocks of a plurality of users and manages the biological information blocks, each information block concerning a biological reaction of a user to each content block during playback of the content block, and the terminal further includes communication means for communicating with the information processing apparatus to acquire the biological information blocks managed by the information processing apparatus.

3. The terminal according to claim 2, further comprising:
user specifying means for specifying a similar user who has a biological reaction similar to that of the user of the information processing terminal during playback of the same content block from among the users providing the biological information blocks to the information processing apparatus on the basis of the biological information blocks acquired through the communication means from the information processing apparatus, wherein
the group specifying means specifies a group of content blocks, to which the users have similar biological reactions, on the basis of the biological information acquired through the acquiring means and the biological information, concerning the biological reaction of the similar user specified by the user specifying means, among the biological information blocks acquired through the communication means.

4. A method for information processing, the method comprising the steps of:
acquiring biological information concerning a biological reaction of a user to each content block during playback of the content block;
specifying a group of content blocks, to which the user has similar biological reactions during playback, on the basis of the acquired biological information;
specifying as recommended content a content block belonging to the same group as that to which a reference content block belongs; and
presenting information concerning the recommended content to the user.

5. A program that allows a computer to perform a process comprising the steps of:
acquiring biological information concerning a biological reaction of a user to each content block during playback of the content block;
specifying a group of content blocks, to which the user has similar biological reactions during playback, on the basis of the acquired biological information;
specifying as recommended content a content block belonging to the same group as that to which a reference content block belongs; and
presenting information concerning the recommended content to the user.

6. An information processing terminal comprising:
an acquiring unit configured to acquire biological information concerning a biological reaction of a user to each content block during playback of the content block;
a group specifying unit configured to specify a group of content blocks, to which the user has similar biological reactions during playback, on the basis of the biological information acquired through the acquiring unit;
a recommended content specifying unit configured to specify as recommended content a content block belonging to the same group as that to which a reference content block belongs; and
a recommending unit configured to present information concerning the recommended content specified by the recommended content specifying unit to the user.
